(19) United States
(12) Patent Application Publication
(10) Pub. No.: US 2025/0322831 A1
(43) Pub. Date: Oct. 16, 2025

(54) VOICE COMMAND RECOGNITION FOR HUMAN-ROBOT COMMUNICATION

(71) Applicant: Intel Corporation, Santa Clara, CA (US)

(72) Inventors: Hector Alfonso Cordourier Maruri, Guadalajara (MX); Georg Stemmer, Munich (DE); Laura Gonzalez Ojeda, Tlajomulco de Zuñiga (MX); Monica Rivera Aguilera, Zapopan (MX); Nathan Mataya, Santa Clara, CA (US); Priyanka Dhage, Cedar Park, TX (US); Johan Rivera, Tempe, AZ (US); Karla Cruz-Lee, Tucson, AZ (US); Saran Poovarodom, Beaverton, OR (US)

(73) Assignee: Intel Corporation, Santa Clara, CA (US)

(21) Appl. No.: 19/250,285

(22) Filed: Jun. 26, 2025

Related U.S. Application Data
(60) Provisional application No. 63/739,006, filed on Dec. 26, 2024.

(51) Int. Cl. G10L 15/22; B25J 13/00; G10L 15/10

(52) U.S. Cl. CPC G10L 15/22; B25J 13/003; G10L 15/10; G10L 2015/223

(57) ABSTRACT

Techniques for the use of verbal commands in human-robot communication. The number of tasks the robot can perform is limited to a specific set, while providing syntactic flexibility to users. The system includes two components: a speech recognizer for speech-to-text conversion and a natural language understanding module that maps the text to a command for the robot. After speech is transcribed to text, a nearest neighbor classifier can be applied in the high dimensional space of embedding tokens. Multiple variants of each command are provided in a database of reference embeddings, and the classifier can identify the k nearest reference embedding tokens to determine the command. The text similarity model allows for quick detection solutions to be deployed locally on a robot or other device. Local deployment reduces potential latency caused by a cloud connection, which can be important in many assistant robot applications.

### CROSS-REFERENCE TO RELATED APPLICATIONS

This application is related to and claims the benefit of priority under 35 U.S.C. § 119(e) to U.S. Provisional Application No. 63/739,006 titled “Voice Command Recognition for Human-Robot Communication” filed on Dec. 26, 2024, which is hereby incorporated by reference in its entirety.

### TECHNICAL FIELD

This disclosure relates generally to voice command recognition, and in particular to a voice command recognition for human-robot communication.

### BACKGROUND

As robots become more ubiquitous, people will want to communicate with the robots. In some scenarios, a person may want to talk to a robot in order to assign a task to a robot. Verbal commands may be used in human-robot communication so long as the robot recognizes and understands the command. However, people may not remember specific commands exactly.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A-1B illustrate example diagrams of a process for robot command and control, in accordance with various embodiments.

FIG. 2 illustrates an example of alternate phrasing, in accordance with various embodiments.

FIG. 3 is a block diagram illustrating an example of a k-nearest neighbor classifier applied using alternative phrasings, in accordance with various embodiments.

FIG. 4 illustrates an example of a sentence transformer fed three phrases, in accordance with various embodiments.

FIG. 5 illustrates example results of a sentence transformer model, in accordance with various embodiments.

FIG. 6 is a flow chart illustrating a method of command detection, in accordance with various embodiments.

FIG. 7 illustrates an example DNN, in accordance with various embodiments.

FIG. 8 is a block diagram of an example computing device, in accordance with various embodiments.

### DETAILED DESCRIPTION

### Overview

Systems and methods are provided for the use of verbal commands in human-robot communication: a person (the user) utters a command to assign a task to a robot. In various scenarios, the number of tasks the robot can perform is limited to a specific set. Syntactic flexibility is provided since humans are not expected to memorize a set of pre-determined commands exactly. The speech understanding module includes two components: a speech recognizer for speech-to-text conversion and a natural language understanding module that maps the text to a command.

Speech-to-text conversion is performed using a large vocabulary speech recognition engine that is not limited to a fixed set of phrases. Systems and methods are provided for mapping the output of the speech recognizer to one out of a set of possible commands corresponding to the tasks the robot can perform. The system generates the most likely phrasing of a collection of commands, so the semantic search becomes easier, robust against speech recognition errors, and less reliant on external modules.

In human-robot communications, spoken interfacing has become a popular option to allow a more natural, human-like collaboration. When speaking to a robot, the user is expected to provide verbal commands to the robot for specific tasks. For the verbal commands, some semantic flexibility is important since humans are not expected to (or likely to) memorize the commands a robot is to receive. One way to provide this flexibility is to use semantic text similarity algorithms for sentence classification, in which the command sentence is turned, via tokenization, into an embedding (a fixed length vector of numbers), to be compared with tokens from the intended command sentences. Sentences with a similar meaning will produce numerically similar embeddings. Therefore, the system can rely on how good the embedding model is at detecting the real meaning of each phrase. The systems and methods can be used in tandem with a wake-up word, which allows a system to distinguish if the user is giving it an order, against the user just speaking to other persons.

Many current systems use specific, highly specialized commands. Users memorize specifically worded commands so that they can be clearly distinguished. This can be cumbersome for users, due to intensive training and the restricted number of available commands. Some systems convert a command sentence into an embedding token (i.e. a vector of numbers), to be compared with tokens from the intended command phrases. This strategy relies on how well the embedding model can generate a token that represents the real meaning of a phrase, independently of how the user formulated the request. While this strategy can offer some simplicity and flexibility, models with good semantic representation are large and more “expensive” in computing resources.

Large Language Models (LLMs) can understand complex sentences and compare them to the available command sentences, with a very high level of sophistication. However, these models are so large and computationally demanding that they cannot be deployed locally and can add unreasonable latency and computer costs.

According to various implementations, semantic similarity and sentence classification systems and methods are provided. In some examples, a nearest neighbor classifier is provided, which can be applied in the high dimensional space of embedding tokens. The robustness and accuracy of this classifier is increased by creating more reference vectors. In some examples, multiple variants (i.e., additional phrasings) of each command are produced, which are obtained manually and with sophisticated LLMs. As the new phrasings may be partially very similar or even overlap for some commands, the nearest neighbor classifier can be generalized to a k-nearest neighbor approach (k-NN), which performs a majority voting of the k-nearest embedding tokens. In some examples, each of the k-nearest embedding tokens has a corresponding class, and majority voting includes counting number of the k-nearest embedding tokens corresponding to various classes, such that the class with the most k-nearest embedding tokens is selected as the class for the input embedding. According to various examples, the systems and methods provided herein can perform a lightweight semantic similarity routine which allows faster comparisons and detects the correct command without putting too much weight into the semantic text similarity model.

According to various embodiments, the systems and methods provided herein include a text similarity model that is much simpler than other systems and allows for quick detection solutions to be deployed locally on a robot or other device. Local deployment allows text similarity models designed for acceleration with a NPU (Neural Processing Unit). Additionally, local deployment reduces potential latency caused by a cloud connection, which can be important in many assistant robot applications.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Pipeline for Command Detection

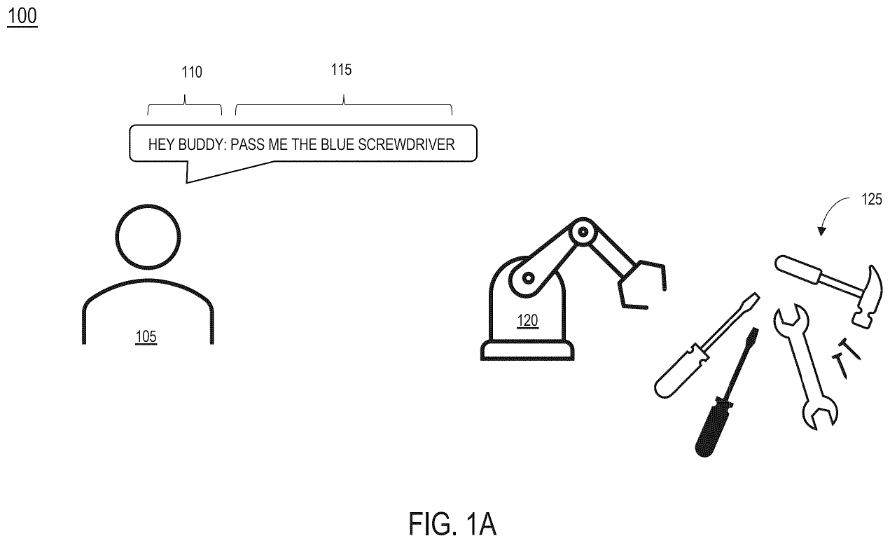

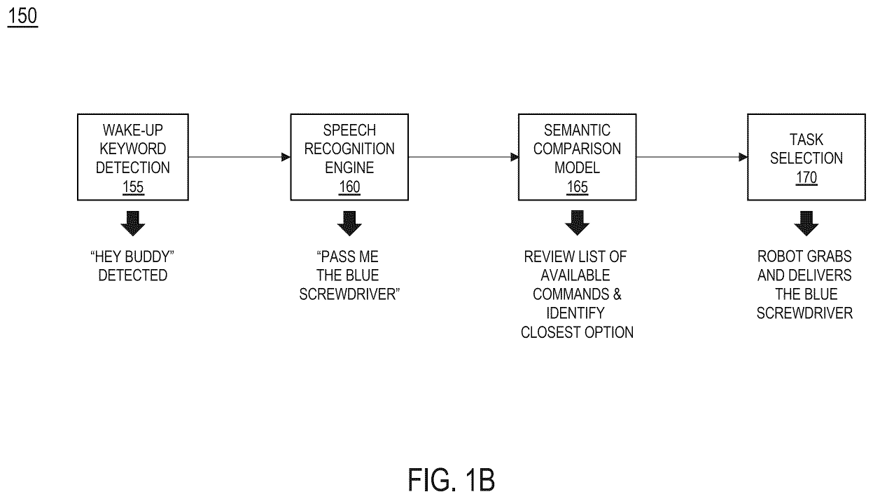

FIGS. 1A and 1B illustrate example diagrams of a process for robot command and control, according to various embodiments. In particular, FIG. 1A is a diagram 100 illustrating a user 105 requesting a selected tool 125 from a robot 120. The user 105 uses a wake-up keyword 110 (e.g., in the illustration shown in FIG. 1A, the wake-up keyword 110 is “hey buddy”) to activate the speech recognition engine at the robot 120. The robot 120 can then recognize and understand the voice command 115 (e.g., in the illustration shown in FIG. 1A, the voice command 115 is “pass me the blue screwdriver”). The robot 120 uses a command detection process, such as shown in the pipeline 150 of FIG. 1B to understand the voice command 115 and select the blue screwdriver from the tools 125.

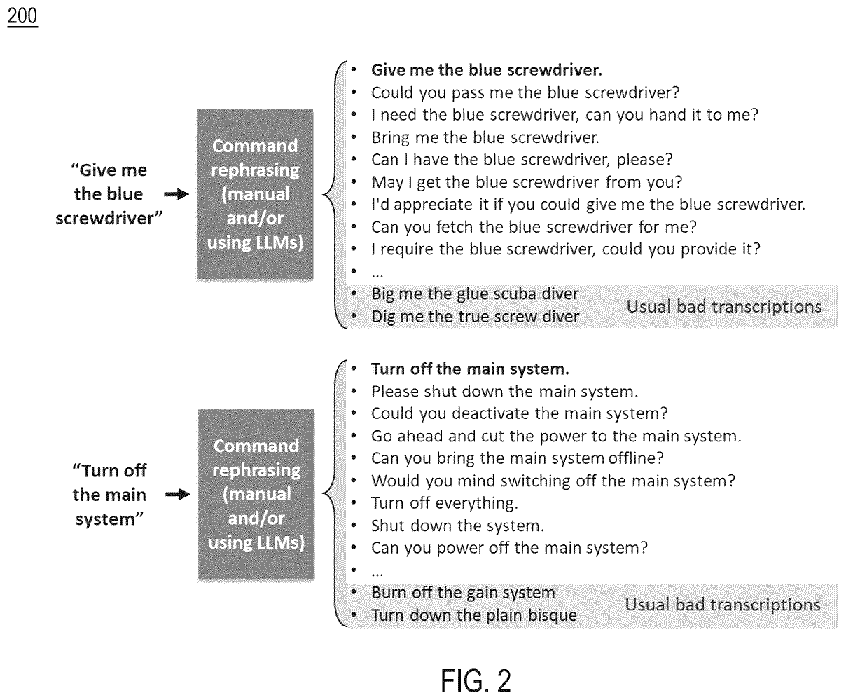

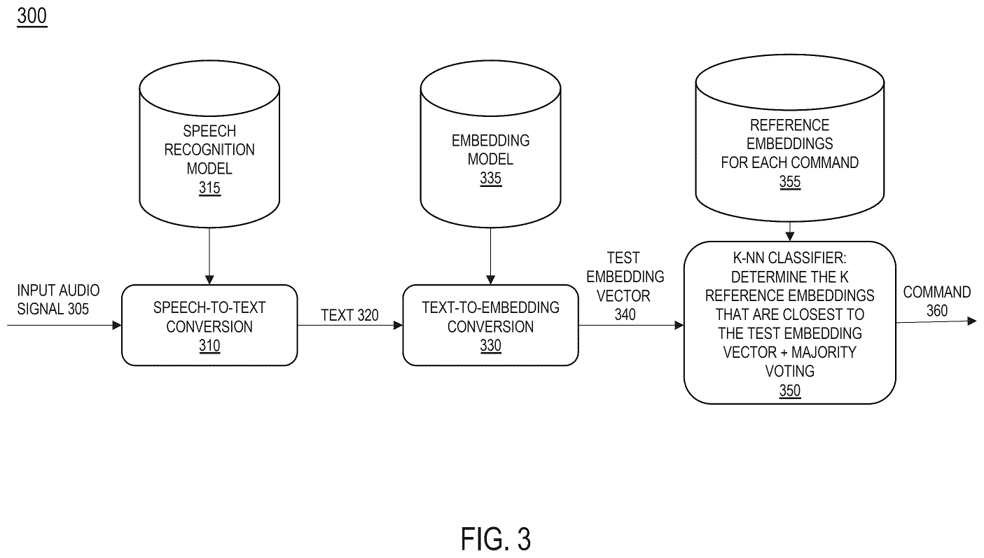

FIG. 1B illustrates a pipeline 150 for the command detection process using a semantic text similarity and sentence classification model, as described in greater details with respect to FIGS. 2 and 3. The illustrated pipeline 150 includes multiple blocks which may be present in a robot and/or which perform functions that may be performed by a robot, such as the robot 120 of FIG. 1A. In various implementations, the robot 120 includes a computer system that implements the various modules in the pipeline 150. In particular, a keyword detection block 155 can wake up a speech recognition engine 160 upon detection of the keyword. The keyword detection block 155 can be an always-on block that performs a lightweight routine which detects a specific keyword.

When the keyword detection block 155 detects the keyword, it alerts the speech recognition engine 160 to start listening for commands. In the illustration of FIG. 1B, the keyword detection block 155 detects the keyword “hey buddy”. In other implementations, the keyword can be any selected keyword. In some examples, the keyword can be selected by the user.

The speech recognition engine 160 can be a full automatic speech recognition (ASR) engine that obtains the transcription of the voice command. In particular, the speech recognition engine 160 can transcribe the voice command that is detected following the detection of the wake-up keyword. In the example of FIGS. 1A and 1B, the voice command that is identified by the speech recognition engine 160 is “pass me the blue screwdriver”.

The transcribed voice command from the speech recognition engine 160 is transmitted to a semantic comparison model 165, which turns the transcribed phrase into an embedding vector. The semantic comparison model 165 can compare the embedding vector with embeddings of available commands. The list of available commands can include many different ways of phrasing commands that each map to a selected list of available tasks, as discussed in greater detail with respect to FIG. 2. In particular, the robot can be configured to perform a selected number of tasks, and each of the available commands can map to a task of the selected number of tasks the robot is configured to perform.

The list of available commands can include one or more bad (i.e., incorrect) transcriptions of the list of available commands, where a bad transcription is an error that can occur at the speech recognition engine 160 such that the speech recognition engine 160 outputs text that is different from what was actually spoken by the user. By including the bad transcriptions in the database of available commands, a transcription error in the input is more likely to result in an accurate command detection and accurate task selection. In some examples, the semantic comparison model 165 identifies a closest task command from the selected list of available task commands, and transmits the identified task command to the task selection module 170.

In some examples, the semantic comparison model compares the embedding vector to reference embeddings in a database of reference embeddings. Each reference embedding in the database corresponds to an available command. The semantic comparison model can be a classifier than identifies k nearest neighbor reference embeddings. In some examples, each nearest neighbor reference embedding corresponds to a task of the selected number of tasks the robot is configured to perform. Using a majority voting technique, the task corresponding to the greatest number of the k nearest neighbor reference embeddings can be identified as the selected task corresponding to the input voice command.

In some examples, at the semantic comparison model 165, the voice command “pass me the blue screwdriver” is mapped to a task command “give me the blue screwdriver”. At the task selection module 170, the selected task command is performed by the robot. Thus, at task selection module 170, the robot grabs the blue screwdriver and delivers to blue screwdriver to the user who spoke the voice command.

In various implementations, the pipeline 150 is a pipeline for a command detection routine that uses a semantic text similarity and sentence classification model. The use case scenario has a very short operation latency and is practical in real-world work scenarios. The semantic test similarity strategy shown in FIGS. 1A-1B can be a tradeoff of simplicity and flexibility when the comparison model is fast enough for each inference. In some examples, models with superior semantic detection can be larger and more computationally expensive for each inference, adding to the latency and/or making the system reliant on cloud resources. Using GPT-like Large Language Models (LLMs) to determine the voice input from users can increase latency, causing the system rely on very large and/or remote processing pipelines.

In some implementations, a basic semantic comparison model can be used with a system that generates the most likely phrasing of a collection of commands, so the semantic search becomes much easier, robust against misclassification, and less reliant on external modules. Additionally, the limited dataset of commands results in a fast and efficient system with minimal latency.

FIG. 2 illustrates an example 200 of alternate phrasing, in accordance with various embodiments. The alternative phrasing can be produced manually, with the help of an LLM, or both. With the alternative phrasing, the semantic comparison model can approximate better the phrase the user uttered, as it will be like any of these phrases. Additionally, the new alternatives to the command phrasing cover the effect of speech recognition errors. In some examples, the new alternatives can be modified to reflect typical speech recognition errors, for instance by substituting, deleting, and/or inserting random words. Thus, the list of available commands can include one or more bad transcriptions of the list of available commands. By including the bad transcriptions in the database of available commands, a transcription error in the input is more likely to result in an accurate command detection and task selection.

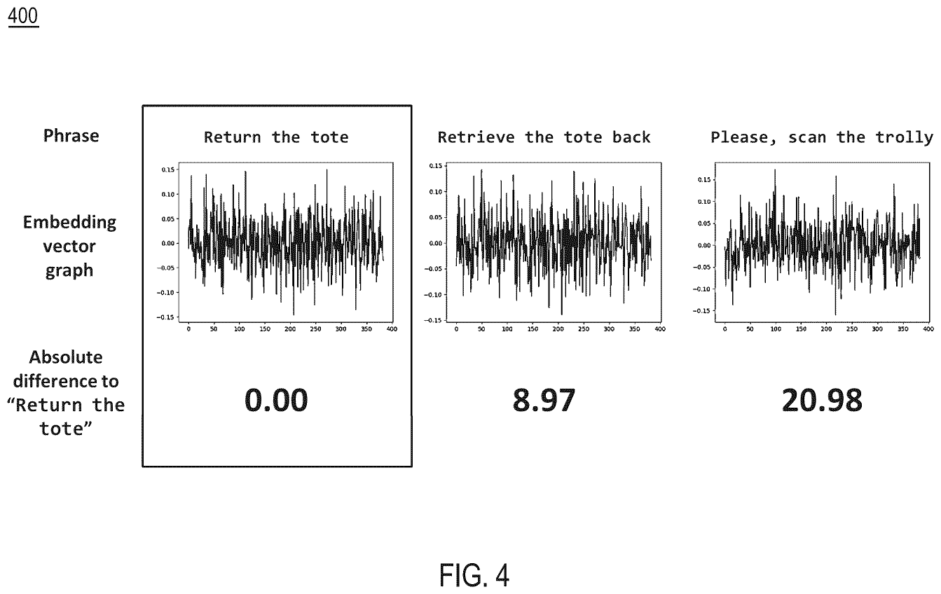

According to some implementations, the systems and methods use a k-Nearest Neighbor (k-NN) classifier. In general, a k-NN classifier determines a distance between a new point and the points in the training dataset, selects the k closest points, and assigns the most common class (command) among the k closest points to the new point. If the process of paraphrasing accidentally creates the same paraphrasing for two different commands (e.g., “pass me the screwdriver” for the two commands “give me the red screwdriver” and “give me the blue screwdriver”), the k-NN classifier will use a majority voting system to correctly classify the command. The majority voting system takes multiple embeddings into account, and selects the class corresponding to the most embeddings. Thus, some “incorrect” transcriptions are included in the dataset to help in cases of expected speech recognition errors. The alternative phrasings can be converted into embeddings and stored in a database with the corresponding command. In some examples, only embeddings that are within a selected distance from the input embedding (as described, for example, with respect to FIG. 4) are included in the majority voting.

Thus, in the example of FIG. 2, the command “Give me the blue screwdriver” can be compared to the nearest neighbor commands “Could you pass me the blue screwdriver?”, “I need the blue screwdriver, can you hand it to me?”, “Bring me the blue screwdriver”, “Can I have the blue screwdriver, please?”, “May I get the blue screwdriver from you?”, “I'd appreciate it if you could give me the blue screwdriver”, “Can you fetch the blue screwdriver for me?”, and “I require the blue screwdriver, could you provide it?”. Additionally, the command “Give me the blue screwdriver” can be compared to incorrect transcriptions “Big me the glue scuba diver”, “Dig me the true screw diver”, etc. The incorrect transcriptions can be mapped as nearest neighbors to the command “Give me the blue screwdriver” in the limited library of available commands.

FIG. 3 is a block diagram 300 illustrating an example of a k-nearest neighbor classifier applied using alternative phrasings in the application phase, in accordance with various embodiments. The input audio signal 305 is received at a speech-to-text conversion block 310, and a speech recognition model 315 can be used to convert the input audio signal 305 to text 320. In some examples, the speech recognition model 315 can be a transformer model. Once the spoken phrase has been determined using the speech recognition model 315, the text 320 is converted into a test embedding vector. In particular, at a text-to-embedded conversion module 330, the text 320 is converted to embeddings using an embedding model 335. In some examples, the embedding model 335 can be a transformer model. The embeddings are represented as a test embedding vector 340.

A k-NN classifier 350 receives the test embedding vector 340, and compares the test embedding vector 340 to the stored embedding vectors. The stored embedding vectors can be stored in a reference embeddings database 355. In various examples, the reference embeddings database 355 includes multiple reference embeddings for each command (e.g., multiple reference embeddings for each command a robot is configured to complete). The k-NN classifier 350 selects the k most similar vectors with respect to some selected distance measure, e.g. cosine distance. A majority vote is applied to identify the k closest vectors and determine the most likely command. For example, for a value of k=3, the k-NN classifier selects the three most similar stored embedding vectors. The k-NN classifier 350 outputs the identified most likely command.

In one example, the test utterance “Pass me the red thing please” may correspond to the phrases “Pass me the blue screwdriver please”, “Pass me the red tweezers” and “Give me the red tweezers”. In this case, the most likely command is “Give me the red tweezers” as most (2 out of 3) of the most similar embedding vectors are paraphrased versions of this command.

In various implementations, the phrasings can be converted into embeddings using a sentence transformer model. That is, in some examples, the embedding model 335 can be a sentence transformer model. Sentence transformer models are a type of neural network. Sentence transformer models are fed a regular sentence and encode the sentence into a numerical vector (i.e., an embedding). An embedding can be a dense vector representation of a sentence or phrase. A sentence transformer model generates embeddings such that semantically similar sentences are close together in vector space.

Sentence transformers can be built on top of pretrained transformer models with modifications for sentence-level tasks. In one example, a sentence transformer includes an input layer, a transformer encoder, a pooling layer, and a similarity computation. The input layer receives one or more sentences as input and tokenizes the input sentence(s) using a tokenizer. The transformer encoder generates a sequence of contextualized token embeddings from the tokenized input. The pooling layer converts the sequence of token embeddings to a fixed-size sentence embedding. The pooling layer can use a pooling strategy such as a first token strategy, a mean pooling strategy (average of all token embeddings), and a max pooling strategy. Similarity computation can be used for inference or for training, and includes comparing embeddings from different sentences using cosine similarity, dot product, or another comparison method.

FIG. 4 illustrates an example of a sentence transformer fed three phrases, in accordance with various embodiments. As shown in FIG. 4, a sentence transformer model is given three different phrases: “Return the tote”, “Retrieve the tote back”, “Please, scan the trolly”. The first two phrases correspond to the same command (RETURN_TOTE), while the third phrase corresponds to a different command (SCAN_TROLLY). For each phrase, an absolute difference between the phrase and the identified command “return the tote” is determined. As shown in FIG. 4, the phrase that corresponds to a different command (i.e., “Please, scan the trolly”) is a much greater distance from the identified command “return the tote” than the other two phrases (i.e., “Return the tote” and “Retrieve the tote back”). The sentence transformer model can be pre-trained. In some examples, a sentence transformer model can be pre-trained with about 1 billion phrase pairs, which can be used from the transformers library. Thus, one embedding is generated for each of the phrases shown in FIG. 4.

As shown in FIG. 4, the two commands (“return the tote” and “retrieve the tote back”) have similar embedding graphs, because their meaning is more similar. However, the third command (“Please, scan the trolly”) shows a more different graph, and this is reflected in the higher absolute difference between graphs (20.98 for the third graph vs. 8.97 for the second graph, and 0.00 for the first graph). The distance between vectors can be calculated with different methods (cosine distance, mean square difference, etc.). In various examples, a selected distance threshold can be set, such that distance that are less than the selected threshold are grouped together as having the same meaning and distances that are greater than the selected threshold are determined to have a different meaning. The specific sentence transformation technique, or the embedding comparison technique can vary.

In some examples, the systems and methods provided herein perform well with minimal latency and acceptable processing delays. If a GPU and/or NPU is not available (e.g., being needed for other tasks), the systems and methods provided herein remain fully implementable. In some examples, robots with close interaction with humans will perform multiple parallel AI tasks in real time (e.g. image recognition with various cameras, Lidar-based obstacle detection, voice to text transcription, etc.). This means that even high performing inference acceleration hardware can become limited by all these models being loaded in memory for quick inferencing. The systems and methods provided herein are memory efficient, can be implemented locally (without cloud connectivity), and still allow a natural voice interaction for most scenarios. The systems and methods provided herein lead to the best accuracy at the lowest latency for the given hardware platform.

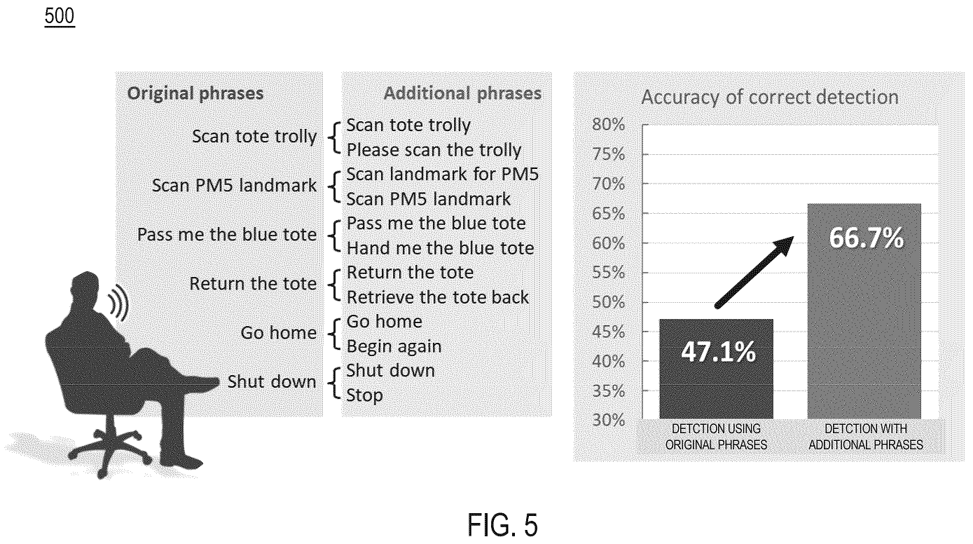

FIG. 5 illustrates example results of a sentence transformer model, in accordance with various embodiments. In particular, as shown in FIG. 5, when just using a list of original phrases the sentence transformer model performs with an accuracy of about 47%. In various examples, the original phrases each correspond with a command and/or task that a robot is trained to perform. When an additional phrase is added for each command and/or task, however, the accuracy of the sentence transformer model jumps to about 67%. For the accuracy of correct detection data, voice recordings from ten different people were used for each phrase, and the speakers are asked to repeat multiple commands, two times each. The recordings were transcribed using an automatic speech recognition engine. The word error rate of a transcription of the recordings was ˜32%, indicating that the output sentences had some missed transcriptions. Then, the transcriptions were fed into a command detection pipeline using semantic text similarity with a sentence transformation model. The tokens were compared with a list of original phrases and an enhanced list of additional phrases to measure the correct detection of commands. The detection accuracy results can be seen in FIG. 5, in which an improvement in accuracy of almost 20% was obtained by adding one additional phrase per command and/or task, keeping everything else the same in the pipeline.

In various implementations, the systems and methods provided herein include adding multiple additional phrases for each command and/or task, further increasing accuracy of correct detection. As discussed above, the additional phrases can include incorrect transcriptions of phrases to further encompass common potential errors and increase accuracy of command detection. The systems and methods have a limited number of available commands and/or tasks that a robot can complete, and thus, even when the database of phrases include multiple phrases mapped to each command, there are a limited number of comparisons, resulting in a system that is very efficient and operates with minimal latency.

### Example Method for Command Detection

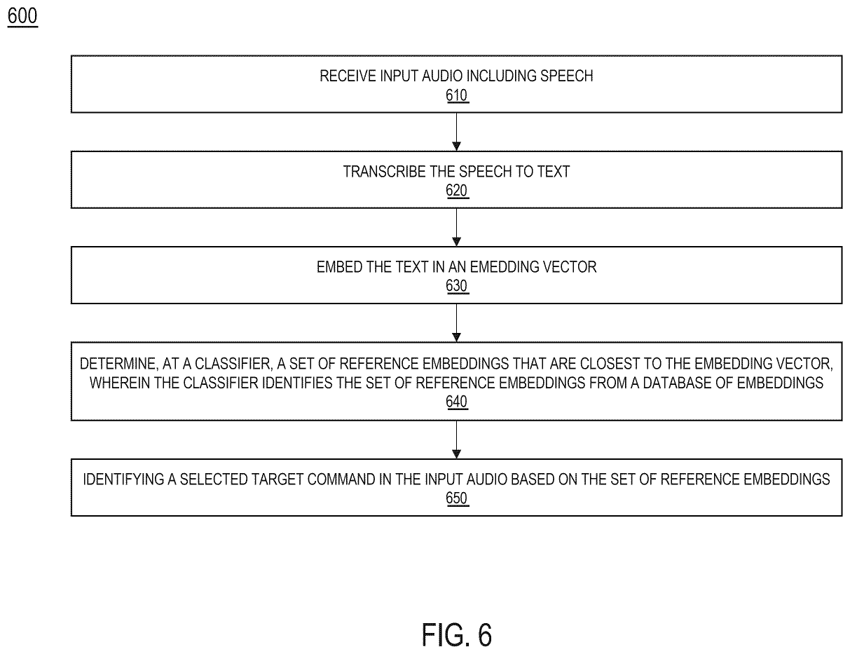

FIG. 6 is a flow chart illustrating a method 600 of command detection, in accordance with various embodiments. Although the method 600 is described with reference to the flowchart illustrated in FIG. 6, many other methods for command detection may alternatively be used. For example, the order of execution of the elements in FIG. 6 may be changed. As another example, some of the steps may be changed, eliminated, or combined. In various examples, the method 600 can be implemented by command detection module, such as the command detection pipeline 150 of FIG. 1B. Similarly, the method 600 can be implemented by command detection module in a robot, such as the robot 120 of FIG. 1.

At 610, input audio including speech is received. The input audio can be received at a microphone, such as a microphone installed in a robot. In some examples, a wake-up word can be detected that initiates a speech recognition engine. For instance, the robot can include a keyword detection module that detects one or more selected wake-up words and initiates the speech recognition engine.

At 620, the speech in the input audio is transcribed to text. In some examples, a speech recognition engine converts the speech to text. In some examples, the speech recognition engine detects the start and end of a phrase and/or sentence in the speech of the input audio.

At 630, the transcribed text is embedded in an embedding vector. In some examples, the transcribed text is embedded using an embedding model, such as a transformer. The embedding vector representing the transcribed text is input to a classifier, such as a k-nearest neighbors classifier. In various example, the embedding vector is a numerical representation of the transcribed text, such as an n-dimensional array of numbers.

At 640, a set of reference embeddings that are closest to the embedding vector are identified. In some examples, the set of reference embeddings that are closest to the embedding vector are identified at a classifier. The classifier identifies the set of reference embeddings from a database of embeddings. The database of embeddings includes representations of multiple reference phrases for each target command of a set of target commands, where each reference phrase is stored as a reference embedding in the database of embeddings. In some examples, the classifier determines a distance between the embedding vector and each of the reference embeddings in the database of embeddings, and identifies k reference embeddings that are closest to the embedding vector. That is, the classifier identifies the k reference embeddings that have the smallest distance from the embedding vector, and the k reference embeddings are the set of reference embeddings. In some examples, the method 600 is performed by a computing system in a robot, and the set of target commands that the reference embeddings in the database of embeddings map to represent a set of actions and/or tasks that a robot is configured to complete.

At 650, a selected target command is identified. In particular, a selected target command corresponding to the speech in the input audio is identified based on the set of reference embeddings identified at the classifier. The set of reference embeddings identified at the classifier each represent a target command of the set of target commands. In some examples, the target command corresponding to the greatest number of reference embeddings of the set of reference embeddings can be identified as the selected target command corresponding to the speech in the input audio. In some examples, the distance between the embedding vector and each reference embedding of the set of reference embeddings can be used as weight, such that the target command corresponding to each reference embedding of the set of reference embeddings is given a weight depending on the distance.

### Example Deep Learning System

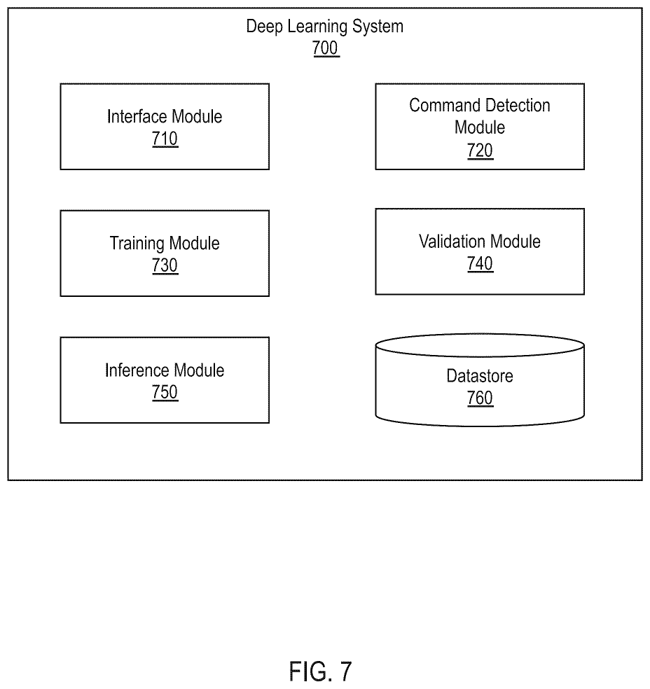

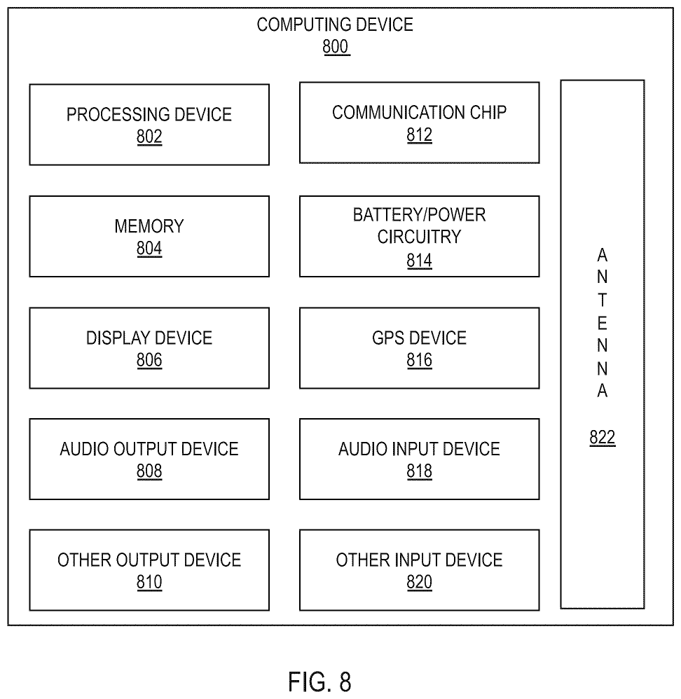

FIG. 7 is a block diagram of an example deep learning system 700, in accordance with various embodiments. The deep learning system 700 trains DNNs for various tasks, including audio-based command detection. In some examples, the deep learning system 700 can be used for a command detection and/or transcription. In some examples, the deep learning system 700 can be used to identify a set of phrases corresponding to each command, and in some examples, the deep learning system 700 can be used to identify a set of incorrect transcriptions corresponding to various phrases for each command. The deep learning system 700 includes an interface module 710, a command detection module 720, a training module 730, a validation module 740, an inference module 750, and a datastore 760. In other embodiments, alternative configurations, different or additional components may be included in the deep learning system 700. Further, functionality attributed to a component of the deep learning system 700 may be accomplished by a different component included in the deep learning system 700 or a different system. The deep learning system 700 or a component of the deep learning system 700 (e.g., the training module 730 or inference module 750) may include the computing device 800 in FIG. 8.

The interface module 710 facilitates communications of the deep learning system 700 with other systems. As an example, the interface module 710 supports the deep learning system 700 to distribute trained DNNs to other systems and/or to distribute command detection templates to other systems, e.g., computing devices configured to apply DNNs to perform tasks. As another example, the interface module 710 establishes communications between the deep learning system 700 with an external database to receive data that can be used to train DNNs or input into DNNs to perform tasks. In some embodiments, data received by the interface module 710 may have a data structure, such as a matrix. In some embodiments, data received by the interface module 710 may be audio, such as an audio stream.

The command detection module 720 processes the received audio signal to identify spectral characteristics of the input data. In general, the command detection module 720 reviews the input data and can be used to identify speech and/or to convert speech to text. In some examples, the command detection module 720 can be used to identify phrases corresponding to selected commands to add to a reference embedding database. In some examples, the command detection module 720 can be used to convert transcribed speech data to an embedding vector.

The training module 730 trains DNNs by using training datasets. In some embodiments, a training dataset for training a DNN may include audio streams. In some examples, the training module 730 trains the command detection module 720. The training module 730 may receive received filtered audio data for processing with the command detection module 720 as described herein.

In some embodiments, a part of the training dataset may be used to initially train the command detection module 720, and the rest of the training dataset may be held back as a validation subset used by the validation module 740 to validate performance of a trained command detection module 720. The portion of the training dataset not including the tuning subset and the validation subset may be used to train the command detection module 720.

The training module 730 also determines hyperparameters for training the command detection module 720. Hyperparameters are variables specifying the command detection module 720 training process. Hyperparameters are different from parameters inside the command detection module 720 (e.g., weights of filters). In some embodiments, hyperparameters include variables determining the architecture of the command detection module 720, such as number of hidden layers, etc. Hyperparameters also include variables which determine how the command detection module is trained, such as batch size, number of epochs, etc. A batch size defines the number of training samples to work through before updating the parameters of the command detection module 720. The batch size is the same as or smaller than the number of samples in the training dataset. The training dataset can be divided into one or more batches. The number of epochs defines how many times the entire training dataset is passed through the entire network. The number of epochs defines the number of times that the deep learning algorithm works through the entire training dataset. One epoch means that each training sample in the training dataset has had an opportunity to update the parameters inside the command detection module. An epoch may include one or more batches. The number of epochs may be 1, 10, 50, 100, or even larger.

The training module 730 defines the architecture of the command detection module 720, e.g., based on some of the hyperparameters. The architecture of the command detection module 720 includes an input layer, an output layer, and a plurality of hidden layers. The input layer of a command detection module 720 may include tensors (e.g., a multidimensional array) specifying attributes of the input, such as weights and biases, attention scores, and/or activations. The output layer includes labels of objects in the input layer. The hidden layers are layers between the input layer and output layer. In various examples, the command detection module can be a transformer model, a recurrent neural network (RNN), and/or a deep neural network (DNN). When the command detection module includes a convolutional neural network (CNN), the hidden layers may include one or more convolutional layers and one or more other types of layers, such as pooling layers, fully connected layers, normalization layers, softmax or logistic layers, and so on. The convolutional layers of the DNN abstract the input to a feature map that is represented by a tensor specifying the features. A pooling layer is used to reduce the spatial volume of input after convolution. It is used between two convolution layers. A fully connected layer involves weights, biases, and neurons. It connects neurons in one layer to neurons in another layer. It is used to classify input between different categories by training.

In the process of defining the architecture of the DNN, the training module 730 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 730 defines the architecture of the command detection module 720, the training module 730 inputs a training dataset into the command detection module 720. The training dataset includes a plurality of training samples. An example of a training dataset includes a input phrases corresponding to various commands for tasks the robot can complete.

The training module 730 may train the command detection module 720 for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 730 finishes the predetermined number of epochs, the training module 730 may stop updating the parameters in the DNN. The DNN having the updated parameters is referred to as a trained DNN.

The validation module 740 verifies accuracy of trained DNNs. In some embodiments, the validation module 740 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 740 may determine an accuracy score measuring the precision, recall, or a combination of precision and recall of the command detection module. The validation module 740 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 740 may compare the accuracy score with a threshold score. In an example where the validation module 740 determines that the accuracy score of the augmented model is lower than the threshold score, the validation module 740 instructs the training module 730 to re-train the command detection module. In one embodiment, the training module 730 may iteratively re-train the command detection module until the occurrence of a stopping condition, such as the accuracy measurement indication that the command detection module may be sufficiently accurate, or a number of training rounds having taken place.

The inference module 750 applies the trained or validated command detection module to perform tasks. The inference module 750 may run inference processes of a trained or validated command detection module 720. In some examples, inference makes use of the forward pass to produce model-generated output for unlabeled real-world data. For instance, the inference module 750 may input real-world data into the command detection module 720 and receive an output of the command detection module 720. The output of the command detection module 720 may provide a solution to the task for which the command detection module is trained for.

The inference module 750 may aggregate the outputs of the command detection module to generate a final result of the inference process. In some embodiments, the inference module 750 may distribute the command detection module to other systems, e.g., computing devices in communication with the deep learning system 700, for the other systems to apply the command detection module to perform the tasks. The distribution of the command detection module 720 may be done through the interface module 710. In some embodiments, the deep learning system 700 may be implemented in a server, such as a cloud server, an edge service, and so on. The computing devices may be connected to the deep learning system 700 through a network. Examples of the computing devices include edge devices.

The datastore 760 stores data received, generated, used, or otherwise associated with the deep learning system 700. For example, the datastore 760 stores video processed by the command detection module 720 or used by the training module 730, validation module 740, and the inference module 750. The datastore 760 may also store other data generated by the training module 730 and validation module 740, such as the hyperparameters for training command detection modules, internal parameters of trained command detection modules (e.g., values of tunable parameters of activation functions, such as Fractional Adaptive Linear Units (FALUs)), etc. In the embodiment of FIG. 7, the datastore 760 is a component of the deep learning system 700. In other embodiments, the datastore 760 may be external to the deep learning system 700 and communicate with the deep learning system 700 through a network.

### Example Computing Device

FIG. 8 is a block diagram of an example computing device 800, in accordance with various embodiments. In some embodiments, the computing device 800 may be used for at least part of the systems in FIGS. 1-7. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include a video input device 818 or a video output device 808, but may include video input or output device interface circuitry (e.g., connectors and supporting circuitry) to which a video input device 818 or video output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 804 may include memory that shares a die with the processing device 802. In some embodiments, the memory 804 includes one or more non-transitory computer-readable media storing instructions executable for speech recognition, speech transcription, and/or command detection, e.g., the method described above in conjunction with FIG. 6 or some operations performed by the DNN system 700 in FIG. 7. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 512 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 512 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include a video output device 808 (or corresponding interface circuitry, as discussed above). The video output device 808 may include any device that generates an audible indicator, such as speakers, headsets, or earbuds, for example.

The computing device 800 may include a video input device 818 (or corresponding interface circuitry, as discussed above). The video input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include a video codec, a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### SELECT EXAMPLES

The following paragraphs provide various examples of the embodiments disclosed herein.

Example 1 provides a computer-implemented method, including receiving an input audio signal including speech; converting the speech in the input audio signal to text; embedding the text in an embedding vector; determining, at a classifier, a set of reference embeddings that are closest to the embedding vector, where the classifier identifies the set of reference embeddings from a database of reference embeddings, where the database of reference embeddings includes a plurality of reference phrase embeddings for each target command of a set of target commands; and identifying a selected target command of the set of target commands in the speech of the input audio signal based on the set of reference embeddings.

Example 2 provides the computer-implemented method according to example 1, where the database of reference embeddings includes embeddings of a plurality of bad transcriptions for each target command.

Example 3 provides the computer-implemented method according to examples 1-2, where the plurality of reference phrase embeddings for each target command includes incorrect transcriptions of at least one reference phrase.

Example 4 provides the computer-implemented method according to examples 1-3, further including identifying a corresponding class associated with each of the set of reference embeddings, and identifying a selected corresponding class associated with a majority of references embeddings in the set of reference embeddings.

Example 5 provides the computer-implemented method according to example 4, where the selected corresponding class corresponds with the selected target command.

Example 6 provides the computer-implemented method according to examples 1-5, further including determining a distance between the embedding vector and each reference embedding in the database of reference embeddings.

Example 7 provides the computer-implemented method according to example 6, where determining the set of reference embeddings includes identifying a subset of reference embeddings from the database of reference embeddings, where each of the subset of reference embeddings has a corresponding distance from the embedding vector that is less than a selected threshold distance, and where the subset of reference embeddings is the set of reference embeddings.

Example 8 provides the computer-implemented method according to examples 1-7, where the classifier is a k-nearest neighbor classifier.

Example 9 provides one or more non-transitory computer-readable media storing instructions executable to perform operations, the operations including receiving an input audio signal including speech; converting the speech in the input audio signal to text; embedding the text in an embedding vector; determining, at a classifier, a set of reference embeddings that are closest to the embedding vector, where the classifier identifies the set of reference embeddings from a database of reference embeddings, where the database of reference embeddings includes a plurality of reference phrase embeddings for each target command of a set of target commands; and identifying a selected target command of the set of target commands in the speech of the input audio signal based on the set of reference embeddings.

Example 10 provides the one or more non-transitory computer-readable media according to example 9, where the database of reference embeddings includes embeddings of a plurality of bad transcriptions for each target command.

Example 11 provides the one or more non-transitory computer-readable media according to examples 9-10, where the plurality of reference phrase embeddings for each target command includes incorrect transcriptions of at least one reference phrase.

Example 12 provides the one or more non-transitory computer-readable media according to examples 9-11, f the operations further including identifying a corresponding class associated with each of the set of reference embeddings, and identifying a selected corresponding class associated with a majority of references embeddings in the set of reference embeddings.

Example 13 provides the one or more non-transitory computer-readable media according to example 12, where the selected corresponding class corresponds with the selected target command.

Example 14 provides the one or more non-transitory computer-readable media according to examples 9-13, the operations further including determining a distance between the embedding vector and each reference embedding in the database of reference embeddings.

Example 15 provides the one or more non-transitory computer-readable media according to example 14, where determining the set of reference embeddings includes identifying a subset of reference embeddings from the database of reference embeddings, where each of the subset of reference embeddings has a corresponding distance from the embedding vector that is less than a selected threshold distance, and where the subset of reference embeddings is the set of reference embeddings.

Example 16 provides the one or more non-transitory computer-readable media according to examples 9-15, where the classifier is a k-nearest neighbor classifier.

Example 17 provides an apparatus, including a computer processor for executing computer program instructions; and a non-transitory computer-readable memory storing computer program instructions executable by the computer processor to perform operations including receiving an input audio signal including speech; converting the speech in the input audio signal to text; embedding the text in an embedding vector; determining, at a classifier, a set of reference embeddings that are closest to the embedding vector, where the classifier identifies the set of reference embeddings from a database of reference embeddings, where the database of reference embeddings includes a plurality of reference phrase embeddings for each target command of a set of target commands; and identifying a selected target command of the set of target commands in the speech of the input audio signal based on the set of reference embeddings.

Example 18 provides the apparatus according to example 17, where the database of reference embeddings includes embeddings of a plurality of bad transcriptions for each target command.

Example 19 provides the apparatus according to examples 17-18, where the plurality of reference phrase embeddings for each target command includes incorrect transcriptions of at least one reference phrase.

Example 20 provides the apparatus according to examples 17-19, further including identifying a corresponding class associated with each of the set of reference embeddings, and identifying a selected corresponding class associated with a majority of references embeddings in the set of reference embeddings.

Example 21 provides the apparatus according to example 20, where the selected corresponding class corresponds with the selected target command.

Example 22 provides the apparatus according to example 17-21, the operations further including determining a distance between the embedding vector and each reference embedding in the database of reference embeddings.

Example 23 provides the apparatus according to example 22, where determining the set of reference embeddings includes identifying a subset of reference embeddings from the database of reference embeddings, where each of the subset of reference embeddings has a corresponding distance from the embedding vector that is less than a selected threshold distance, and where the subset of reference embeddings is the set of reference embeddings.

Example 24 provides the one or more non-transitory computer-readable media according to examples 17-23, where the classifier is a k-nearest neighbor classifier.

Example 25 provides the computer-implemented method according to claims 1-8, the one or more non-transitory computer-readable media according to examples 9-16, and/or the apparatus according to claims 17-24, wherein each of the set of reference embeddings has a corresponding class, and further comprising determining a selected class that has a greatest number of reference embeddings from the set of reference embeddings, and wherein identifying the selected target command comprises identifying the selected class.

Example 26 provides the computer-implemented method according to examples 1-5, where determining the set of reference embeddings that are closest to the embedding vector further comprises determining a distance between the embedding vector and each reference embedding in the database of reference embeddings.

Example 27 provides the computer-implemented method according to example 26, where each of the set of reference embeddings has a corresponding distance from the embedding vector that is less than a selected threshold distance.

Example 28 provides the one or more non-transitory computer-readable media according to examples 9-13, where determining the set of reference embeddings that are closest to the embedding vector further comprises determining a distance between the embedding vector and each reference embedding in the database of reference embeddings.

Example 29 provides the one or more non-transitory computer-readable media according to example 28, where each of the set of reference embeddings has a corresponding distance from the embedding vector that is less than a selected threshold distance.

Example 30 provides the apparatus according to example 17-21, where determining the set of reference embeddings that are closest to the embedding vector further comprises determining a distance between the embedding vector and each reference embedding in the database of reference embeddings.

Example 31 provides the apparatus according to example 22, where each of the set of reference embeddings has a corresponding distance from the embedding vector that is less than a selected threshold distance.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. A computer-implemented method, comprising:
receiving an input audio signal including speech;
converting the speech in the input audio signal to text;
embedding the text in an embedding vector;
determining, at a classifier, a set of reference embeddings that are closest to the embedding vector, wherein the classifier identifies the set of reference embeddings from a database of reference embeddings, wherein the database of reference embeddings includes a plurality of reference phrase embeddings for each target command of a set of target commands; and
identifying a selected target command of the set of target commands in the speech of the input audio signal based on the set of reference embeddings.

2. The computer-implemented method according to claim 1, wherein the database of reference embeddings includes embeddings of a plurality of incorrect transcriptions for each target command.

3. The computer-implemented method according to claim 1, wherein the plurality of reference phrase embeddings for each target command includes incorrect transcriptions of at least one reference phrase.

4. The computer-implemented method according to claim 1, further comprising identifying a corresponding class associated with each of the set of reference embeddings, and identifying a selected corresponding class associated with a majority of references embeddings in the set of reference embeddings.

5. The computer-implemented method according to claim 4, wherein the selected corresponding class corresponds with the selected target command.

6. The computer-implemented method according to claim 1, wherein determining the set of reference embeddings that are closest to the embedding vector further comprises determining a distance between the embedding vector and each reference embedding in the database of reference embeddings.

7. The computer-implemented method according to claim 6, wherein each of the set of reference embeddings has a corresponding distance from the embedding vector that is less than a selected threshold distance.

8. The computer-implemented method according to claim 1, wherein the classifier is a k-nearest neighbor classifier.

9. One or more non-transitory computer-readable media storing instructions executable to perform operations, the operations comprising:
receiving an input audio signal including speech;
converting the speech in the input audio signal to text;
embedding the text in an embedding vector;
determining, at a classifier, a set of reference embeddings that are closest to the embedding vector, wherein the classifier identifies the set of reference embeddings from a database of reference embeddings, wherein the database of reference embeddings includes a plurality of reference phrase embeddings for each target command of a set of target commands; and
identifying a selected target command of the set of target commands in the speech of the input audio signal based on the set of reference embeddings.

10. The one or more non-transitory computer-readable media according to claim 9, wherein the database of reference embeddings includes embeddings of a plurality of incorrect transcriptions for each target command.

11. The one or more non-transitory computer-readable media according to claim 9, wherein the plurality of reference phrase embeddings for each target command includes incorrect transcriptions of at least one reference phrase.

12. The one or more non-transitory computer-readable media according to claim 9, f the operations further comprising identifying a corresponding class associated with each of the set of reference embeddings, and identifying a selected corresponding class associated with a majority of references embeddings in the set of reference embeddings.

13. The one or more non-transitory computer-readable media according to claim 12, wherein the selected corresponding class corresponds with the selected target command.

14. The one or more non-transitory computer-readable media according to claim 9, wherein determining the set of reference embeddings that are closest to the embedding vector further comprises determining a distance between the embedding vector and each reference embedding in the database of reference embeddings.

15. The one or more non-transitory computer-readable media according to claim 14, wherein each of the set of reference embeddings has a corresponding distance from the embedding vector that is less than a selected threshold distance.

16. The one or more non-transitory computer-readable media according to claim 9, wherein the classifier is a k-nearest neighbor classifier.

17. An apparatus, comprising:
a computer processor for executing computer program instructions; and
a non-transitory computer-readable memory storing computer program instructions executable by the computer processor to perform operations comprising:
receiving an input audio signal including speech;
converting the speech in the input audio signal to text;
embedding the text in an embedding vector;
determining, at a classifier, a set of reference embeddings that are closest to the embedding vector, wherein the classifier identifies the set of reference embeddings from a database of reference embeddings, wherein the database of reference embeddings includes a plurality of reference phrase embeddings for each target command of a set of target commands; and
identifying a selected target command of the set of target commands in the speech of the input audio signal based on the set of reference embeddings.

18. The apparatus according to claim 17, wherein the plurality of reference phrase embeddings for each target command includes incorrect transcriptions of at least one reference phrase.

19. The apparatus according to claim 17, wherein determining the set of reference embeddings that are closest to the embedding vector further comprises determining a distance between the embedding vector and each reference embedding in the database of reference embeddings.

20. The apparatus according to claim 19, wherein each of the set of reference embeddings has a corresponding distance from the embedding vector that is less than a selected threshold distance.
